(19) United States
(12) Patent Application Publication
(10) Pub. No.: US 2005/0192999 A1
(43) Pub. Date: Sep. 1, 2005

(54) System and method of virtualizing physical locations

(76) Inventors: Scott James Cook, Santa Monica, CA (US); Lincoln Travis Ross Gasking, West Hollywood, CA (US); Jean-Guy Poitras, Santa Monica, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/991,947

(22) Filed: Nov. 18, 2004

Related U.S. Application Data
(60) Provisional application No. 60/524,343, filed on Nov. 21, 2003.

(51) Int. Cl. G06F 9/26; G06F 15/16

(52) U.S. Cl. 707/102; 709/219

(57) ABSTRACT

The system and method provide an intuitive and user-friendly way to store information about physical locations on a computer network. In particular, a physical location information collection is created and stored on a computer network at a network address that corresponds to the physical address of the physical location to which the information pertains. The network address for information about the physical location at 123 Main Street, for example, incorporates at least a portion of 123 Main Street. The physical address can be incorporated into a Uniform Resource Locator (“URL”) domain name, such as, for example, www.123mainstreet.com. Alternatively, the physical address can be incorporated into another portion of a network address, such as, for example, www.buildingaddress.com/123mainstreet/.

### REFERENCE TO RELATED APPLICATIONS

This application claims priority to U.S. Provisional Patent Application No. 60/524,343, which was filed Nov. 21, 2003 and is entitled “VIRTUALLY INTERLINKED COLLABORATIVE INFORMATION SYSTEM BASED ON PHYSICAL LOCATIONS OF TANGIBLE REAL PROPERTY.” The foregoing provisional patent application is hereby incorporated by reference in its entirety into this application.

### BACKGROUND OF THE INVENTION

1. Field of the Invention

Embodiments of the system and method described herein relate generally to methods and systems for organizing information geographically for retrieval over the Internet and other computer networks.

2. Description of the Related Art

The Internet and other computer networks provide access to a large number of databases, information sources, and services that reside on such computer networks. Furthermore, a number of computer applications, including browsers and search engines, provide user-friendly interfaces for navigating the many network-accessible databases, information sources, or services. Because of the vast amount of information and services available on such computer networks, and because of the ease with which such information and services can be accessed, it is often said that the Internet and similar computer networks provide a virtual world of information and services. Metaphorically, language used to describe activities in the physical world has been used to describe users' interactions with this virtual world. For example, users are said to “visit” websites and other virtual locations on computer networks, much like people visit buildings. Generally, such visits to virtual locations occur when a user requests, using an application such as a browser, a network address of information or services available on the network. Many network addressing schemes exist. An often used network addressing scheme is the Uniform Resource Locator (“URL”), which is used to address information and services available on the Internet.

Physical locations also have addresses. For example, buildings typically are identified by street addresses, such as 123 Main Street. Buildings and other geographical locations can also be identified by a number of other addressing schemes, such as, for example, geographical coordinates, global positioning system (“GPS”) coordinates, telephone numbers associated with the physical location, and the like.

Individuals and organizations have attempted to link the physical world with the virtual world by searching for information about physical locations stored on the Internet and other computer networks. For example, sometimes users desire to find, within the virtual world, information about physical locations, driving and parking directions for such locations, businesses located at such locations, local restaurants in and near such locations, reviews of such businesses and restaurants made by residents of such locations, and other similar information. Conventionally, users have used web portals, search engines, specialized services such as Mapquest, and other conventional information services, to search for information about physical locations. Users enter a query including a name or address into such conventional information services, and the conventional services execute scripts or other applications to generate results based on the query.

Conventional information services, however, do not provide integrated virtual locations identified by network addresses that correspond to physical addresses of physical locations. Furthermore, conventional information services do not provide integrated virtual locations that provide a variety of information, such as directions, restaurant reviews, entertainment options, and the like, related to corresponding physical locations. Moreover, conventional information services do not provide integrated virtual locations that provide a level of enhanced access and content control to members of a community, such as building tenants, associated with corresponding physical locations.

### SUMMARY OF THE INVENTION

Embodiments of the system and method described herein provide an intuitive and user-friendly way to store information about physical locations on a computer network. In particular, in embodiments, a physical location information collection is created and stored on a computer network at a network address that corresponds to the physical address of the physical location to which the information pertains. The network address for information about the physical location at 123 Main Street, for example, incorporates at least a portion of 123 Main Street. In one embodiment, the physical address is incorporated into a Uniform Resource Locator (“URL”) domain name, such as, for example, www.123mainstreet.com. In another embodiment, the physical address is incorporated into another portion of a network address, such as, for example, www.buildingaddress.com/123mainstreet/.

Advantageously, therefore, embodiments described herein provide a system and method for organizing information and retrieving documents from a database using the physical address of the location for which the information and documents pertain. Advantageously, this mechanism of storing information of physical locations is intuitive and user-friendly. With regard to the physical world, people are familiar with each physical location having an address. The embodiments described herein, therefore, take the familiar concept of the physical address as an identifier for each physical location and employs the physical address as a unique identifier for information in the virtual world. Accordingly, embodiments described herein provide for the “virtualization” of physical locations. That is, embodiments described herein create a “virtual location” corresponding to each of a large number of physical locations. The virtual locations are organized and related geographically into communities, such as, for example, blocks, neighborhoods, cities, counties, states, and the like.

According to an embodiment, the system provides a global virtually inter-linked information system in which the physical address of real property, vacant land, and/or physical structures on land are included within a network address, such as a URL, based on street number and street (or sector) name for the purpose of providing information and services in relation to the structure and its neighborhoods. Thus, tangible real property and vacant land addresses become virtual via a URL. In one embodiment, the physical address is included in a domain name portion of a URL. In another embodiment, the physical address is included in another portion of a URL, such as, for example, in a URL path.

By creating a uniform naming convention, the system allows consistent direct access to an individual property via entering its related URL or other network address into a stationary or portable Internet-accessible device. Alternatively or additionally, access to the entire information network can be provided via a centralized search engine located at a website, such as, for example, BuildingAddress.com. By building familiarity in the naming convention, a party (regardless of their location or local knowledge) can access physical location information locally or worldwide by typing in the consistent address of the physical location. The system thus provides a lattice of virtual locations or physical location information collections.

In one embodiment, the system maintains one or more databases that store information about physical locations. The one or more databases further include information about the relationships between physical locations. For example, the databases relate physical locations that are in a given geographical area, such that, for example, locations within the same street, block, neighborhood, city, or other geographical designation are related with each other. Advantageously, the system uses such information about multiple physical locations and their interrelationships to periodically generate or update virtual locations pertaining to the physical locations. Such virtual locations include such information as people, businesses, services, entertainment, and news that is associated with each physical location. Advantageously, because the system determines which physical locations are near to each other or are otherwise related, the information related to one particular physical location, such as 123 Main Street, can include information about businesses located at a different location that is near 123 Main Street. Accordingly, a user visiting the virtual location for 123 Main Street, a complex of condominiums, can find out about shopping opportunities available across the street at 200 Main Street, an outdoor mall.

In one embodiment, the system allows for the creation of a user community associated with each virtual location. Using such a community, community members associated with a location, such as 123 Main Street, can be presented with additional information about the location that pertain particularly to community members. For example, a community of the tenants of the physical location at 123 Main Street can be set up to allow those tenants to access information about private events for the tenants at 123 Main Street. Similarly, such a community can allow the tenants at 123 Main Street to post and view bulletins that relate to the community. Advantageously, such communities can be set up for members of a community at a building level (such as tenants of a building), or on a larger geographical scale, such as people who live and work in a certain block, neighborhood, or city.

According to an embodiment, a system for storing and retrieving information comprises a first collection of electronic information pertaining to physical locations, a second collection of electronic information having information related to at least one of the physical locations within the first collection of electronic information, a third collection of electronic information pertaining to users of the system, and a host server. Each of the physical locations is identified by a physical address stored in at least one data field. The host server is interconnected by a computer network to the first collection of electronic information, the second collection of electronic information, and the third collection of electronic information. The host server is configured to receive a network address that has, within the network address, at least one physical address associated with at least one of the physical locations. Furthermore, the host server is also configured to identify, based on the physical address, at least one of the physical locations. Furthermore, the host server is configured to display information about the identified physical location.

In the foregoing embodiment, the physical address can comprise at least one of a street address, a postal address, and a multi-dimensional coordinate. In this embodiment the physical address does not consist entirely of a name of a city. The network address can comprise a plurality of characters, and a majority of such characters can match a physical address corresponding to a physical location. In one embodiment, the characters comprise a combination of numbers, characters, letters, and symbols.

In one embodiment, the physical address comprises at least one Global Positioning System coordinate.

In one embodiment, the second collection of electronic information includes information that indicates a level of relevance of the information to a physical location. Alternatively, information associated with a physical location has a range attribute that indicates a level of relevance of the information to other physical locations.

In one embodiment, the physical address comprises a name of a building. The name of the building may uniquely identify a physical location.

In one embodiment, the physical address comprises a telephone number.

In one embodiment, the network address is entered by a user using a telephone keypad.

In one embodiment, the information about the identified physical location is displayed using a browser.

In one embodiment, the network address comprises a Uniform Resource Locator. For example, the physical address can be included within a domain name of a Uniform Resource Locator. Alternatively, the physical address can be included within a second-level domain portion of a Uniform Resource Locator. As another alternative, the physical address can be included within two characters from the end of a top-level domain of a Uniform Resource Locator. The physical address within the network address can be split into parts.

An embodiment of a method of retrieving information related to a physical location comprises: (1) receiving over a network a user request including a network address that has within the network address at least a portion of a physical address, (2) extracting the physical address from the network address and identifying, from the physical address, at least one information collection comprising information about a physical location corresponding to the physical address, (3) aggregating information from the information collection with information related to the physical location stored in at least one other information collection, and (4) transmitting the information about the physical location and the information related to the physical location to a user.

In the foregoing method, the network can comprise the Internet. Alternatively, the network can comprise a network of cellular telephones.

In the foregoing embodiments, receiving a user request can comprise receiving a user request generated at least in part by a user entering a network address into a browser. Alternatively or additionally, receiving a user request can comprise receiving a user request generated at least in part by a user selecting at least one link on a web page.

The foregoing embodiment can also comprise identifying a user. Identifying a user can comprise a process of self-identification by the user. Alternatively or additionally, identifying a user can comprise identifying a user by the user's physical location at the time that the user invokes the method.

In the foregoing embodiments, receiving a user request can comprise receiving a user request that is made by the user by speaking at least one sound. Alternatively or additionally, receiving a user request can comprise receiving user input on a device that automatically generates, based on the received user input, the user request, and transmits the request over the network. Alternatively or additionally, receiving a user request can comprise receiving a user request that has been manually generated by the user.

In the foregoing embodiments, the network address can comprise a Uniform Resource Locator. [0028] In the foregoing embodiments, the physical address can comprise a street address. Alternatively or additionally, the physical address can comprise a string of characters. The physical address can be at least part of a sub-domain in a Uniform Resource Locator. Alternatively or additionally, the physical address can be at least part of a domain of a Uniform Resource Locator. Alternatively, the physical address can be the whole of a Uniform Resource Locator.

In the foregoing embodiments, the information returned to the user can comprise textual information. Alternatively or additionally, the information returned to the user can comprise graphical information. The information returned can include at least a portion of data that is not directly related to the physical location.

In the foregoing embodiments, the information returned to the user can be in a structured data format. For example, the format can comprise XML. The format can be user-specified. The format can comprise a database.

The foregoing embodiments of the method can further comprise displaying the information returned to the user on a computer screen.

In the foregoing embodiments, the information can be returned to a separate user than the user that made the user request.

The user of the foregoing embodiments can comprise an electronic device, or be a person, or comprise a software program.

In embodiments, the information returned by the method can include advertising. The information returned can also include real estate listings. The real estate listings can be for an area in a defined proximity to the physical location. The information returned can also include traffic information to or from the physical location.

In embodiments of the method, the content and quantity of information returned to the user is dependent on attributes of the user stored in an information collection. For example, in some embodiments, the user can alter the content of information returned on current or subsequent accesses of the system.

In some embodiments of the method, the physical address comprises a telephone number. Alternatively or additionally, the physical address comprises a multi-dimensional coordinate.

An embodiment of a geographical information system comprises a collection of information relevant to a geographical location, an interface to the collection, and an output module. The collection is connected to a network. The interface is configured to provide user access to the collection over the network, such access being provided, at least in part, by receiving, over the network, a network address that identifies the collection. The network address comprises, as a host name of the network address, at least a portion of a physical street address. The output module is configured to retrieve information from the information collection and transmit the information to a user. The system provides a variable level of access for users wherein a user is allowed to alter varying quantities of content in the information collection based on user attributes stored in the information collection.

In the foregoing system, the network can comprise the Internet.

The foregoing system may further comprise a transaction module configured to manage transactions between users related to physical locations stored in the information collection. At least one of such transaction may involve an exchange of money or advertising. At least one of the transaction may specify a time span for the transaction to take effect. With regard to at least one of the transactions, at least one of the parties to the transaction may have the last right of refusal over other parties interested in the transaction. With regard to at least one of the transactions, an auction may be held to determine a party that is allowed to participate in the transaction.

An embodiment of a method of virtualizing physical locations comprises (1) associating a plurality of physical location information collections with physical addresses such that each collection comprises data related to a physical location identified by at least one physical address, (2) receiving a network address that includes a physical address, (3) identifying at least one of the collections based on the physical address included in the network address, and (4) transmitting a portion of the data related to a physical location from the identified collection.

In an embodiment of the foregoing method, the physical address included in the network address can comprise at least a portion of at least one of a street address, a postal address, a building name, a spatial coordinate, and a global positioning system coordinate. Furthermore, the portion of the data related to a physical location that is transmitted can comprise information about at least one of people, restaurants, services, entertainment, and news associated with the physical location.

In an embodiment of the foregoing method, the network address received comprises a Uniform Resource Locator. In one embodiment, the Uniform Resource Locator includes the physical address within a host name of the Uniform Resource Locator. In another embodiment, the Uniform Resource Locator includes the physical address within a path of the Uniform Resource Locator.

The foregoing embodiments of the method can further comprise responding to user requests for interaction with the identified electronic collection of geographical information. In one embodiment, responding to user requests for interaction comprises identifying users that are members of a community associated with the physical location and granting to such community members a higher level of access to the data related to the physical location than is granted to users that are not community members. In one embodiment, users that live within the physical location are identified as members of the community. In one embodiment, the higher level of access granted to community members includes being able to modify at least a portion of the data related to the physical location.

An embodiment of a geographical information system comprises a plurality of physical location information collections connected to a computer network, each collection comprising data related to a physical location identified by at least one physical address, the geographical information system configured to receive a user request comprising a network address that includes a physical address, to identify, based on the physical address included in the network address, one of the collections, and to transmit to the user at least a portion of the data related to the physical location identified by the physical address.

An embodiment of the foregoing system further comprises at least one physical location information collection server, wherein at least two of the collections are stored on the at least one electronic information collection server. Another embodiment further comprises an address resolution module configured to receive, as part of a network address, at least a portion of a physical address, to match the portion of a physical address with one of the physical addresses that identifies a physical location for which data is stored in one of the collections, and to cause the geographical information system to transmit to the user at least a portion of the data related to the physical location identified by the matched physical address. Another embodiment further comprises a global positioning system coordinate module configured to receive, as part of a network address, at least one global positioning system coordinate, to match the global positioning system coordinate with a physical address by determining which physical address corresponds to a physical location located at the global positioning system coordinate, and to cause the geographical information system to transmit to the user at least a portion of the data related to the physical location identified by the matched physical address.

An embodiment of a program storage device stores instructions that when executed perform the process comprising (1) associating a plurality of physical location information collections with physical addresses such that each collection comprises data related to a physical location identified by at least one physical address, (2) receiving a network address that includes a physical address, (3) identifying at least one of the collections based on the physical address included in the network address, and (4) transmitting a portion of the data related to a physical location from the identified collection.

In one embodiment, process performed by the foregoing program storage device further comprises responding to user requests for interaction with the identified collection. Responding to user requests for interaction can comprise identifying users that are members of a community associated with the physical location and granting to such community members a higher level of access to the data related to the physical location than is granted to users that are not community members.

An embodiment of a system for virtualizing physical locations comprises a means for associating a plurality of physical location information collections with physical addresses such that each collections comprises data related to a physical location identified by at least one physical address, a means for receiving a network address that includes a physical address, a means for identifying at least one of the collections based on the physical address included in the network address, and a means for transmitting a portion of the data related to a physical location from the identified collection.

In one embodiment, the foregoing system further comprises means for responding to user requests for interaction with the identified electronic collection of geographical information. In one embodiment, responding to user requests for interaction comprises identifying users that are members of a community associated with the physical location and granting to such community members a higher level of access to the data related to the physical location than is granted to users that are not community members.

In accordance with the foregoing and other embodiments described herein, the system and method described herein allow for the creation and organization of virtual locations that correspond to physical locations. The system and method allow users to easily access such virtual locations by using a network address that includes at least a portion of a physical address. Accordingly, the information is organized and accessed using a type of identification, physical addresses, with which users are familiar. Furthermore, such virtual locations can be related such that when a user visits one virtual location, the user can be presented with related information associated with related locations. Moreover, communities of users can be created and associated with the virtual locations, in which users are granted additional access privileges for information related to locations for which the users are community members. These and other features and advantages are made available by embodiments of the system and method described herein. A skilled artisan will appreciate, in light of this disclosure, that not every feature or advantage described herein is a necessary part of every embodiment, and that some embodiments may have additional features and advantages that have not been described.

### BRIEF DESCRIPTION OF THE DRAWINGS

FIG. 1 is a block diagram illustrating a system of virtualizing physical locations connected to a computer network according to one embodiment.

FIG. 2 is a pictorial diagram that depicts a number of physical locations in a neighborhood.

FIG. 3 is a simplified screen shot that depicts information about physical locations displayed to a user.

FIG. 4 is a block diagram that illustrates components of a network according to an embodiment of the system of virtualizing physical locations.

FIG. 5 is a block diagram that illustrates a geographical information system in accordance with one embodiment of the system.

FIG. 6 illustrates the operation of a GPS coordinate module and an address resolution module.

FIG. 7 is a flowchart that illustrates a process for retrieving information about a physical location as performed by an embodiment of the system.

FIG. 8 is a flowchart that illustrates another process for retrieving information about a physical location as performed by an embodiment of the system.

FIG. 9 is a process flow diagram of a domain name resolution process in accordance with an exemplary embodiment of the system.

FIG. 10 is a sequence diagram of a map generation process in accordance with an exemplary embodiment of the system.

FIG. 11 is an architecture diagram for a host suitable for hosting a portal in accordance with an exemplary embodiment of the system.

FIG. 12 is a sequence diagram of a text-based generation process in accordance with an exemplary embodiment of the system.

### DETAILED DESCRIPTION OF PREFERRED EMBODIMENTS

Embodiments of the system and method described herein provide an intuitive and user-friendly way to store information about physical locations on a computer network. In particular, in embodiments, a physical location information collection is created and stored on a computer network at a network address that corresponds to the physical address of the physical location to which the information pertains. The network address for information about the physical location at 123 Main Street, for example, incorporates at least a portion of 123 Main Street. In one embodiment, the physical address is incorporated into a Uniform Resource Locator (“URL”) domain name, such as, for example, www.123mainstreet.com. In another embodiment, the physical address is incorporated into another portion of a network address, such as, for example, www.buildingaddress.com/123mainstreet/.

Details regarding several illustrative preferred embodiments for implementing the system and method described herein are described below with reference to the figures. At times, features of certain embodiments are described below in accordance with that which will be understood or appreciated by a person of ordinary skill in the art to which the system and method described herein pertain. For conciseness and readability, such a “person of ordinary skill in the art” is often referred to as a “skilled artisan.”

It will be apparent to a skilled artisan, in light of this disclosure, that the system and method described herein can advantageously be implemented using computer software, hardware, firmware, or any combination of software, hardware, and firmware. In one embodiment, the system is implemented as a number of software modules that comprise computer executable code for performing the functions described herein. In one embodiment, the computer-executable code is executed on a plurality of general purpose computers that are interconnected using a computer network as illustrated and described herein. However, a skilled artisan will appreciate, in light of this disclosure, that any module that can be implemented using software to be executed on a general purpose computer can be implemented using a different combination of hardware, software, or firmware. For example, such modules can be implemented completely in hardware using a combination of integrated circuits. Alternatively or additionally, such modules can be implemented completely or partially using specialized computers designed to perform the particular functions described herein rather than by general purpose computers.

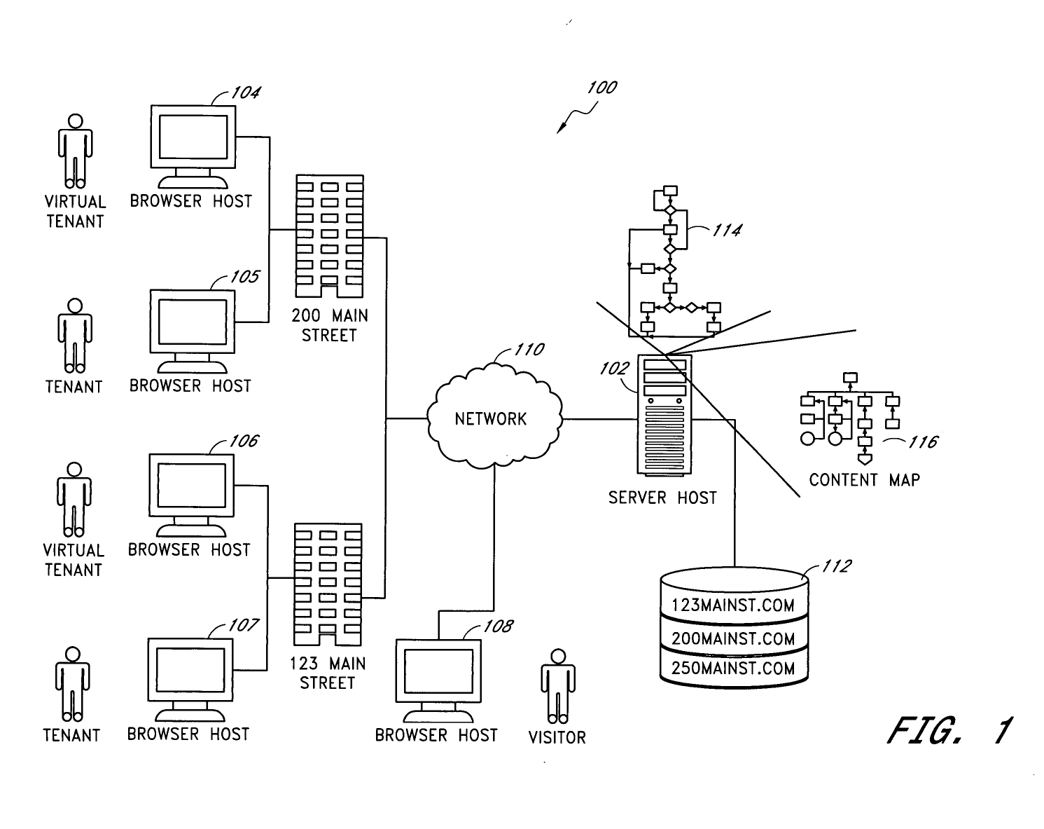

FIG. 1 is a block diagram illustrating a system of virtualizing physical locations connected to a computer network according to one embodiment described herein. As shown, a network environment 100 for embodiments described herein comprises a server host 102, a number of browser hosts 104-108, and a network 110. The network 110 connects the server host 102 to the browser hosts 104-108. A skilled artisan will appreciate, in light of this disclosure, that the server host 102 can be a single host computer, as illustrated, or can be a plurality of host computers distributed over the network 110. At times throughout this disclosure the server host 102 is referred to as a portal server.

According to an embodiment, the server host 102 comprises a plurality of physical location information collections 112, a plurality of interrelationships 114 between the physical location information collections 112, and at least one content map 116 that describes content available from the server host 102 over the network 110. In one embodiment, as illustrated, the content map 116 comprises a logical hierarchy descriptive of a website. A skilled artisan will appreciate in light of this disclosure, however, that the content map 116 may be descriptive of other content accessible on the network 110, and such content need not be limited to a website.

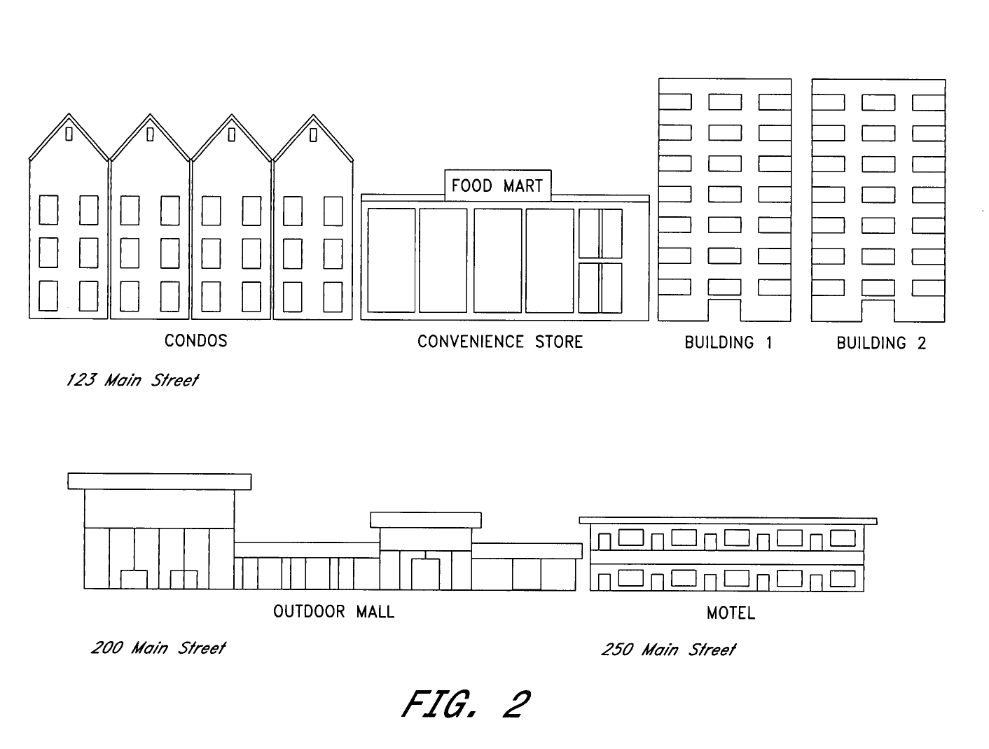

Advantageously, each physical location information collection 112 stores information about a particular physical location. In this way, the physical location information collections 112, taken together, establish a virtual world that describes the physical world. For ease of understanding, the link between the virtual world of the system described herein and the physical world is now described with reference to FIG. 1 and to FIG. 2, which depicts a number of physical locations in a neighborhood.

One physical location information collection 112 may store information about condominiums located at 123 Main Street as shown on FIG. 2. Another may store information about an outdoor mall located at 200 Main Street. Still another may store information about a motel located at 250 Main Street. In one embodiment, the physical location information collections 112 store a wide variety of information about each physical location, such as, for example, information about the people that live or work at the physical location, restaurants in or around the physical location, other businesses in or around the physical location, entertainment available near the physical location, and news items relevant to the physical location. In one embodiment, the physical location information collections 112 are interrelated by the interrelationships 114 such that, for example, when a user accesses the physical location information collection 112 for one physical location, such as the condominiums at 123 Main Street, the user is also presented with relevant information stored in the physical location information collection 112 for other physical locations that relate to the condominiums at 123 Main Street. For example, in a preferred embodiment, when a user accesses the collection 112 for the condominiums at 123 Main Street, the user is also presented with information about shopping opportunities that are available at the outdoor mall across the street at 200 Main Street.

Advantageously, the interrelationships 114 between physical location information collections 112 allow the host server 102 to create a virtual world that parallels the relationships between locations that exist in the physical world that the virtual world describes. For example, in the physical world, when a person visits condominiums at 123 Main Street, the person finds out not only about the condominiums but about the neighborhood around the condominiums. For example, the person finds out about the businesses surrounding the condominiums, such as, for example, an outdoor mall across the street at 200 Main Street or a motel at 250 Main Street. Similarly, the interrelationships 114 allow the portal server 102 to link the virtual location of the condominiums at 123 Main Street with the outdoor mall at 200 Main Street and the motel at 250 Main Street.

Advantageously, the server host 102 stores each physical location information collection 112 such that each collection 112 is accessible using a network address that includes at least a portion of a physical address that identifies the physical location. For example, as illustrated on FIG. 1 with regard to a portal server that serves content using the URL addressing scheme, a domain name portion of a URL comprises a portion of the physical address of a landmark, building, or other piece of real property. Thus, as illustrated, the collection 112 stored at the domain 123mainst.com comprises information about the condominiums at 123 Main Street, as depicted on FIG. 2. The collection 112 stored at the domain 200mainst.com comprises information about the outdoor mall at 200 Main Street. The collection 112 stored at the domain 250mainst.com comprises information about the motel at 250 Main Street.

A skilled artisan will appreciate in light of this disclosure that the server host 102 can store all or some of the physical location information collections 112 such that such collections 112 are accessible using a network address that includes at least a portion of a physical address that identifies the physical location without having a domain name portion of a URL comprise a portion of the physical address. For example, in one embodiment, the server host 102 assigns to a collection 112 a network address that comprises a URL in which a path of a URL comprises a physical address. Such an addressing scheme includes, for example, the network addresses www.buildingaddress.com/123mainst/, www.buildingaddress.com/200mainst/, and www.buildingaddress.com/250mainst/. A skilled artisan will appreciate in light of this disclosure that other network addressing schemes exist as well, including network addressing schemes that do not use URLs. A skilled artisan will appreciate in light of this disclosure that the system described herein can be implemented using any such networking scheme that allows the characters, numbers, and other symbols that make up a physical address to be incorporated into a network address.

In the above illustrative examples of a physical address, street addresses such as 123 Main Street have been described. Street addresses, however, are only one example of a physical address that can be used with the system described herein. A skilled artisan will appreciate in light of this disclosure that many kinds of physical addresses exist and can be used with the system described herein, including, for example, street addresses, telephone numbers, geographical coordinates, GPS coordinates, building names, and the like. In general, as used herein, the term “physical address” is a broad term that encompasses all of the foregoing physical addresses and any other designation that identifies a particular physical location. Particular embodiments of the system use only a subset of the above-listed physical addresses, such as, for example, street addresses only, street addresses and telephone numbers only, or any other subset of the physical addresses listed above. Other embodiments of the system use a subset of the physical addresses listed above together with other types of physical addresses understood by a skilled artisan in light of this disclosure. Still other embodiments of the system do not use any of the physical addresses listed above but do use other types of physical addresses understood by a skilled artisan in light of this disclosure.

In one advantageous embodiment, the server host 102 executes one or more automated processes in order to generate information stored in the collections 112. Furthermore, the server host 102 executes one or more automated processes for organizing the information of the collections 112 so as to create the content maps 116 that describe a navigational hierarchy of how information is presented to users. In one embodiment, the server host 102 generates the information stored in the collections 112 by accessing one or more databases in which information regarding physical locations is stored. Advantageously, relationships between the various physical locations can be derived from the information stored in the databases. For example, in one embodiment, the server host 102 determines which physical locations are located in the same neighborhood, such that information about the neighborhood of a physical location can be presented to a user whenever the user accesses a virtual location corresponding to any one of the physical locations within the neighborhood. In one embodiment, the server host 102 uses templates or scripts to generate content such as a website using the information about physical locations that is stored in a common datastore. The datastore includes information about a variety of physical locations with each physical location being assigned to a network address or domain name that includes the physical address.

In one embodiment, the server host 102 periodically regenerates the information associated with each collection 112. Such periodic regeneration can be triggered by a number of events. In one embodiment, the periodic regeneration occurs on a set schedule, such as, for example, every hour, every two hours, every day, or on a set schedule based on another time period. In one embodiment, the regeneration schedules for each collection 112 are staggered so as to balance the computational load on the server host 102. In one embodiment, the periodic regeneration is triggered when new data is entered into the databases from which the collections 112 are generated. For example, in one embodiment, when information about a newly constructed building, such as 275 Main Street, is entered into the database, a new collection 112 corresponding to 275 Main Street is created by the server host 102. Additionally, since 275 Main Street is related to the other buildings in its area, the collections 112 corresponding to 123 Main Street, 200 Main Street, and 250 Main Street are updated. A skilled artisan will appreciate, in light of this disclosure, that other relationships may be affected, in addition to the relationship of being on the same street as the new location, such that the addition of the new location may cause updates to other collections 112 as well. In one embodiment, periodic regeneration can be triggered by a user, such that a collection 112 is regenerated when a user visits the collection 112.

Advantageously, automatic generation of the collections 112, using one or more common databases, allows for the creation of a large number of virtual locations that correspond to physical locations, in which relationships among the virtual locations correspond to relationships among the corresponding physical locations. As such, each virtual location created by the system described herein is presented to a user within the context of the location's street, block, neighborhood, city, or the like. Furthermore, by accessing a virtual location, a user can receive information not only about the exact physical location corresponding to the virtual location, but can also receive information about the people, restaurants, services, businesses, entertainment, news, and other information associated with the physical location.

In one embodiment, the information stored in each collection 112 is made accessible over the network 110 to a number of browser hosts 104-108. As used herein, a “browser host” is a broad term that encompasses both a computer running a web browser as known in the art or a computer running any other client software for accessing content on a computer network. Advantageously, the browser hosts 104-108 can allow a variety of user's to access the system, including for example, tenants that live or work in one of the physical locations represented by one of the collections 112, and visitors that do not live or work in a physical location for which the visitor seeks information. As illustrated, for example, the browser hosts 104 and 105 are being accessed by tenants of 200 Main Street, the browser hosts 106 and 107 are being accessed by tenants of 123 Main Street, and the browser host 108 is being accessed by a visitor. A skilled artisan will appreciate, in light of this disclosure, that the computers being used by a user who is a tenant need not be located within the physical location of which the user is a tenant. Furthermore, a skilled artisan will appreciate, in light of this disclosure, that a user may be a tenant at some times while accessing the system but may be a visitor at other times. For example, the user accessing the browser host 105 is a tenant, as illustrated, of 200 Main Street. However, with regard to transactions in which the user accesses a collection 112 corresponding to a 123 Main Street, the user is only a visitor.

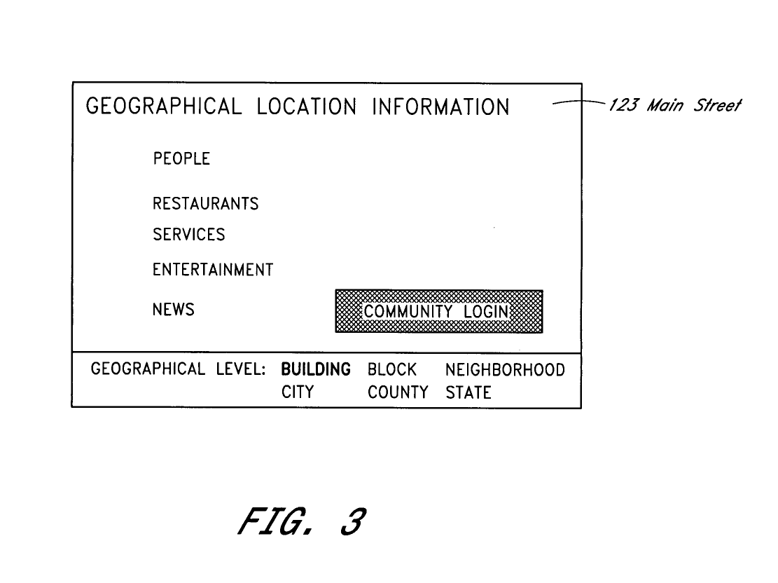

In one embodiment, the system transmits information to the browser hosts 104-108 in response to user requests to access a virtual location, such as, for example, the virtual location at 123mainst.com. In one embodiment, each virtual location, or collection 112, presents information regarding people, restaurants, services, entertainment, news, and other relevant information associated with the location. A simplified exemplary screen shot of a menu for information associated with 123 Main Street is illustrated in FIG. 3. As illustrated in FIG. 3, in one advantageous embodiment, a user can specify a level of geographical detail for the information. For example, as illustrated, the user can request information related to the building 123 Main Street, information related to 123 Main Street's block, or information related to 123 Main Street's neighborhood, city, county, or state. A skilled artisan will appreciate, in light of this disclosure, that many other geographical levels exist and that the system can be implemented to operate on any such geographical level.

In one embodiment, the server host 102 is creates a community of people that contribute information to, and acquire information from, the server host 102. Advantageously, the server host 102 provides a community for each virtual location stored in the collections 112. In one embodiment, upon accessing content for a particular collection 112, such as, for example, the collection 112 for 123 Main Street, as illustrated in FIG. 3, the user is presented, along with information about the collection 112, an opportunity to log in to a virtual community associated with 123 Main Street. In one embodiment, as shown in FIG. 3, community members can log in to the virtual community by invoking a community login button. Advantageously, community members are associated with the physical location that corresponds to the virtual location. For example, in one embodiment, the community members that are allowed to access the community login for the virtual location associated with 123 Main Street are tenants of the physical condominiums located at 123 Main Street.

In a preferred embodiment, community members have a higher level of access to at least a portion of the information provided by the server host 102 for a particular collection 112. For example, in one embodiment, tenants of the example condominiums at 123 Main Street have increased access to the virtual location associated with 123 Main Street. Such increased access includes, for example, being able to post to community bulletin boards, having access to information about private events that are scheduled to occur within the community, and having access to services that allow tenants to reserve or rent property of the community, such as recreation rooms, swimming pools, and the like. Advantageously, embodiments of the system allow for the creation of communities at any geographic level, such that, for example, a community can be built for tenants of 123 Main Street, or for all tenants of any location on Main Street, or for tenants of any location within the block of 123 Main Street. Similarly, a community can be established on the neighborhood level, city level, county level, state level, or at the level of any other geographical designation.

In the case where the physical property is an apartment building or a commercial building, a plurality of tenants access the server host 102 via a communications network such as the Internet. The tenants access the host server 102 using a browser hosted by a browser host, such as, for example, any of the browser hosts 104-108, or any alternate device configured to communicate with a host on a computer network, such as, for example, a wireless phone configured to communicate with a computer network. Other people who are affiliated with the building, herein termed virtual tenants, or those not affiliated with the building, herein termed “visitors”, may also access the portal server. The tenants are allowed special community privileges, such as those previously described, including, for example, access to tenant-related information such as contact information and bulletins. Tenants, virtual tenants, or visitors may add content to the datastore that is related to the real property, depending on the access privileges granted to each type of user. For example, the tenants may provide reviews of local services or provide specialized instructions on how to access the real property's services. In one embodiment, new information is validated by an assignee or tenant. In one embodiment, some people or groups of people can be prevented from adding information regarding a location. For example, in one embodiment, visitors can be prevented from adding information, while tenants are allowed to add information.

Once populated with information, the datastore provided by the collections 112 and the websites or other content generated by the host server 102 become information assets for both tenants and visitors. As the collections 102 are generated such that each virtual location is related to surrounding virtual locations, the information for each of the physical locations is advantageously combined to create neighborhood information assets that, may be navigated using physical locations and their surroundings by varying scales, such as block, neighborhood, area, city, county, state, region, country, contingent, and world. In one embodiment, all of the collections 112 are stored in a single location, such as, for example, in a single server. In other embodiments, the collections 112 are stored in a number of locations, such as in several servers connected via a distributed network. In a preferred embodiment, whether the collections 112 are stored in one location or several, the system is able to access all of the collections 112 in order to create content that relates the collections 112 together.

In embodiments in which at least a portion of a location's physical address is used as part of a domain name to designate a network address for a corresponding virtual location, each virtual location has at least one domain name at which information about the physical location is stored. For example, in one embodiment, the virtual location corresponding to 123 Main Street is stored at 123mainst.com. However, human beings often refer to a physical address in informal ways. For example, humans often abbreviate an address, such as 123 Main Street, as 123 Main St., or 123 Main, or the like. Accordingly, according to embodiments of the system, multiple network addresses can be created for a single address, such as, for example, “123mainstreet.com,” “123mainst.com,” and “123main.com.” In embodiments in which the physical address is stored in a part of a network address that is not the domain name, the network addresses can be, for example, “www.buildingaddress.com/123mainstreet/,” “www.buildingaddress.com/123mainst/,” and “www.buildingaddress.com/123main/.”

Additionally, in some cases slang terms are used to refer to certain locations. Finally, some physical locations may be better known by names describing the history of the physical location, such as an apartment building named for a famous person. In this case, the domain name of the physical location may not be readily available to a user who is trying to access the server host 102 to obtain a particular physical location's website. In this case, the name used by a user must be resolved to the actual physical address domain name. Accordingly, in embodiments of the system, slang names or common names for a particular physical location can be substituted for street numbers and names, such that the slang or common name serves as a physical address for the physical location.

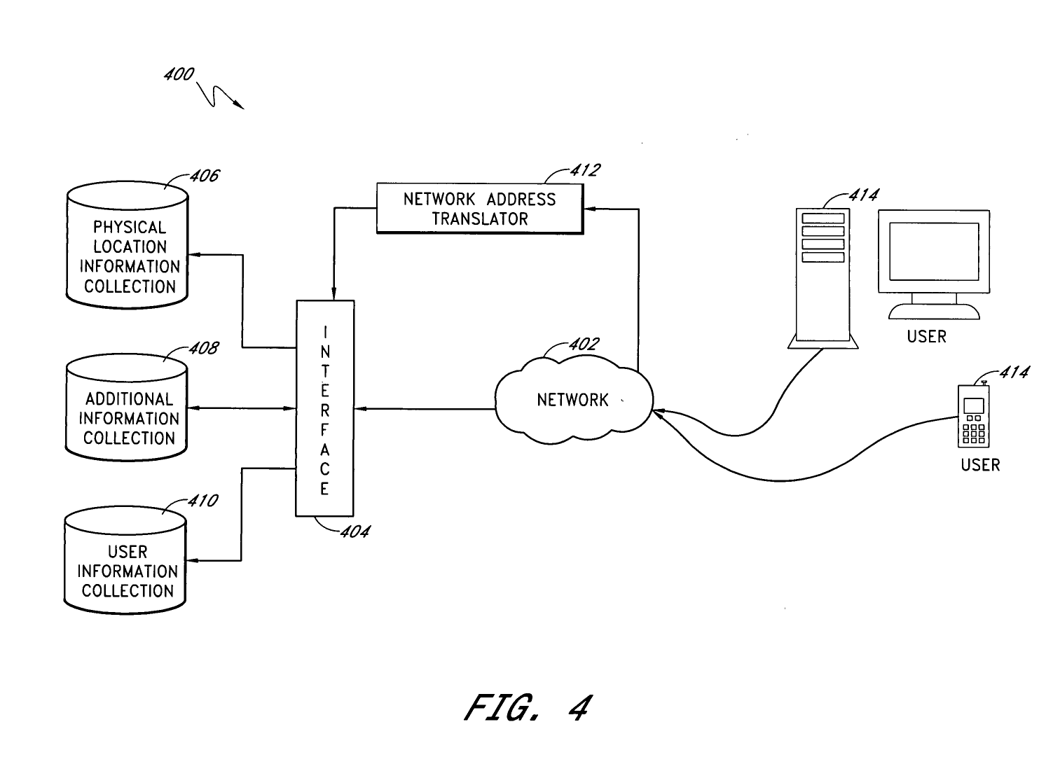

FIG. 4 is a block diagram that illustrates components of a network according to an embodiment of the system described herein. The diagram 400 illustrates a network 402, an interface 404 for accessing a number of information collections 406, 408, and 410, a network address translator 412, and a number of user access devices 414. A user uses one of the user access devices 414, which can be, for example, a computer, a wireless telephone, or any other device configured to allow a user to communicate with a network, to connect with the network 402. The user access device 414 transmits a user request to the network 402, which forwards the user request to the interface 404 or the network address translator 412, depending on whether the user request is in the correct format to retrieve information from the various collections 406, 408, and 410.

If the user request is in the correct format, the user request is sent to the interface 404. As indicated above, a user request includes a network address that identifies a physical location using at least a portion of a physical address. The physical address is, in one embodiment, a street address. Alternatively, the physical address can be a postal address, a geographical coordinate, a GPS coordinate, a telephone number, a common name of a recognized building, a slang name for a physical location, or the like. Based on the network address provided to the interface 404, the interface 404 accesses one or more information collections 406, 408, and 410 in order to retrieve information about the physical location identified by the physical address that has been stored in the system. In one embodiment, a physical location information collection 406 includes information about the physical location identified by the physical address. An additional information collection 408 includes additional information associated with the physical location, such as, for example, information about the physical locations that are geographically near the identified physical location. A user information collection 410 includes information about users associated with the physical location, or community members. A skilled artisan will appreciate, in light of this disclosure, that the collections 406, 408, and 410 can be combined into fewer than three collections, or can be expanded into more than three collections.

In one embodiment, the network address translator 412 comprises one or more modules that determines, based on user input, which network address the user desires to access. In one embodiment, the network address translator 412 takes as input a telephone number, determines a physical location that has such a telephone number, and directs the user to a virtual location or collection associated with the determined physical location. Alternatively or additionally, the network address translator 412 takes as input geographical coordinates, such as, for example, GPS coordinates, determines a physical location that exists at the geographical coordinates, and directs the user to a virtual location or collection associated with the determined physical location. Alternatively or additionally, the network address translator 412 receives a network address that corresponds to more than one physical location. In such a case, if the document being indexed has the same physical address as another, such as 123 Main Street in multiple cities, the user is given the option to select for more information, such as the desired city, in order to accurately provide the information requested. Advantageously, the network address translator 412 provides a mechanism to resolve user requests when such requests are in a format that does not correspond directly to any virtual location.

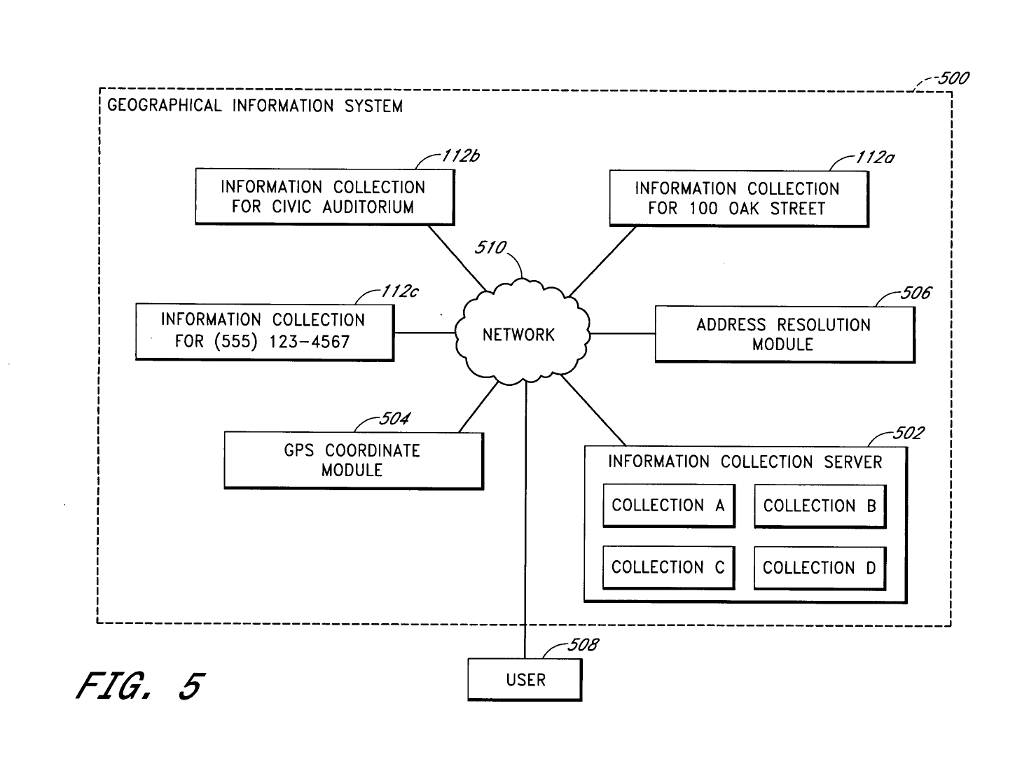

FIG. 5 is a block diagram that illustrates a geographical information system in accordance with one embodiment of the system described herein. In one embodiment, a geographical information system 500 comprises a plurality of virtual locations or information collections 112 associated with physical locations, one or more information collection servers 502, a GPS coordinate module 504, and an address resolution module 506. In one embodiment, all such components are interconnected to each other and to users 508 of the system using a computer network 510.

The information collections 112 have been previously described. As illustrated, each information collection 112 is associated with a particular physical location identified by a physical address. The physical address can be a street address, as with the collection for 100 Oak Street 112a. The physical address can be a common building name, as with the collection for Civic Auditorium 112b. The physical address can be a telephone number, as with the collection for (555) 123-4567 112c. A skilled artisan will appreciate, in light of this disclosure, that the foregoing are illustrative collections only, and that the physical address can be any other type of physical address, including, for example, a geographical coordinate such as a GPS coordinate.

As illustrated, the information collections 112 can exist on separate nodes on a computer network. As also illustrated, two or more of the information collections 112 can coexist on one or more information collection servers 502. A skilled artisan will appreciate, in light of this disclosure, that the illustrated network configuration, in which some of the collections 112 exist on independent network nodes and some of the collections 112 exist on an information collection server 502, is only one example of a network configuration for the described system. Alternatively, all collections 112 can be stored on independent network nodes such that there are no information collection servers 502. As another alternative, all collections 112 can be stored on a single information collection server 502, such that there are no collections 112 stored on an independent network node. A skilled artisan will understand, in light of this disclosure, how to implement any of the foregoing network configurations and any combination of the foregoing configurations.

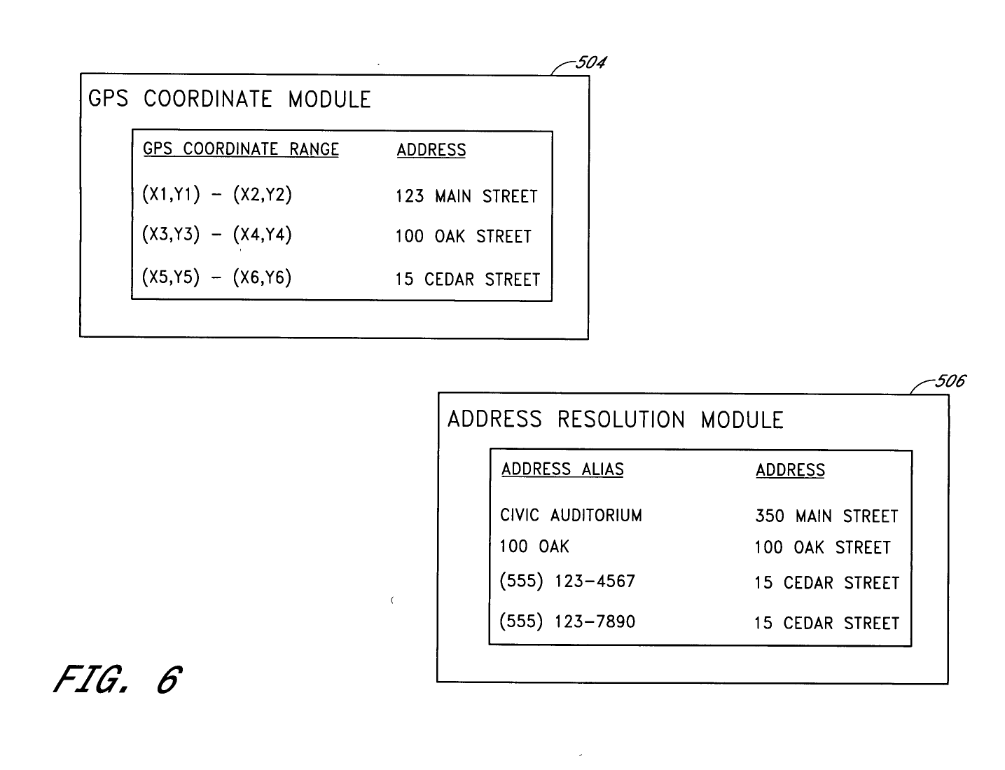

FIG. 6 illustrates the operation of the GPS coordinate module 504 and the address resolution module 506, respectively. The GPS coordinate module 504 associates GPS coordinates or a range of GPS coordinates with a physical location located at the GPS coordinates. For example, as illustrated, the physical location with a physical address of 123 Main Street has a range of GPS coordinates of (X1, Y1)-(X2, Y2). In one embodiment, the range of GPS coordinates defines a box, where a first group of GPS coordinates defines a corner of the box and a second group of GPS coordinates defines an opposite corner of the box. A skilled artisan will appreciate, in light of this disclosure, that more than two GPS coordinates can be used to define a range that is not a box shape. Alternatively or additionally, a single pair of GPS coordinates can be used. In one embodiment, the GPS coordinate module 504 is able to determine which address corresponds to an approximate GPS coordinate, in view of the fact that GPS coordinate readings may have a small degree of error. Advantageously, embodiments that have a GPS coordinate module 504 allow a user to enter GPS coordinates, such as those displayed on a GPS receiver's screen, rather than entering a street address into the system. Advantageously, such GPS coordinates are passed to the GPS coordinate module 504, which identifies the physical location that has a corresponding virtual location stored in the system that is closest to the entered GPS coordinates. The system can then present to the user information about and related to the virtual location identified by the GPS coordinates. The GPS coordinate module 504, while advantageous, is not a required component of all embodiments of the system.

The address resolution module 506 associates different kinds of addresses with a street address. As is generally understood, a physical location can be identified by different addresses. For example, a building with a commonly known name may be identified by such name instead of by its street address. For example, a building located at 350 Main Street may be called the “Civic Auditorium,” and people in the community may refer to that physical location as the “Civic Auditorium” rather than using the street address of 350 Main Street. Similarly, as previously indicated, a street address may have several variations. Accordingly, a person may refer to a location at 100 Oak Street by a shortened form of the address, such as, for example, 100 Oak or 100 Oak St. Additionally, in some cases people may identify a physical location with a phone number associated with the physical location. For example, a client of a business may know several phone numbers within the business, such as, for example (555) 123-4567 and (555) 123-7890, without necessarily knowing where the business is located or the business' address. Although the client may not know the address, records within the address resolution module 506 can be used to determine that the phone numbers are associated with 15 Cedar Street. Accordingly, the address resolution module 506 allows a user to enter an address that may not be the primary address used by the system to identify a particular physical location. After receiving such a non-primary address, the address resolution module 506 finds a matching primary address. Then, using the matching primary address, the system can find the correct virtual location for the user.

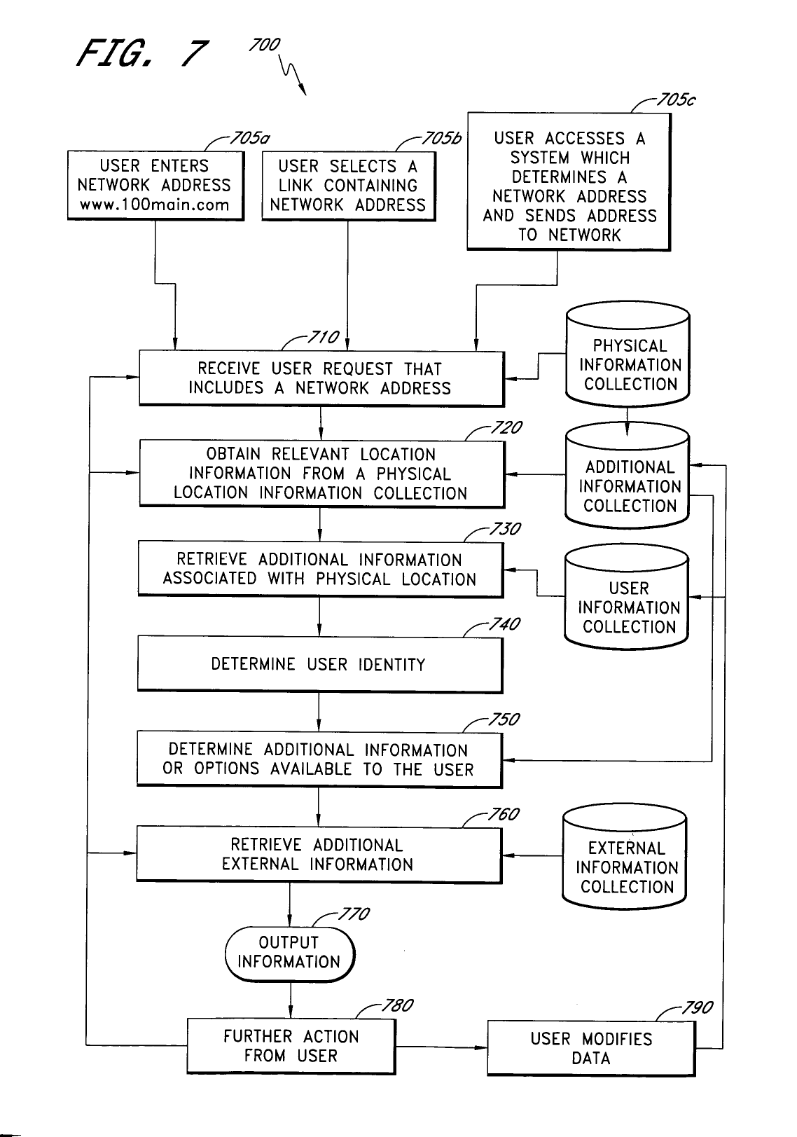

FIG. 7 is a flowchart that illustrates a process for retrieving information about a physical location as performed by an embodiment of the system. A process 700 of retrieving information about a physical location begins at one of a block 705a, 705b, or 705c. At the block 705a, a user enters a network address that includes a physical address. At the block 705b, a user selects a link that includes a network address with a physical address. At the block 705c, a user enters information, and based on that information, the system determines a network address that includes a physical address. In one embodiment, the process 700 performs the function of the block 705c by using the GPS coordinate module 504, the address resolution module 506, or some other module configured to determine an address for a physical location based on information received from a user. Accordingly, after the completion of the block 705a, 705b, or 705c, the user has entered, in some way, a network address that includes a physical address.

At the block 710, the process 700 receives the user request that includes a network address with a physical address. At the block 720, the process 700 obtains relevant information about the physical location identified by the physical address in the network address. At the block 730, the process 700 retrieves additional information associated with the physical location, such as, for example, information about other physical locations that are related to the identified physical location. At the block 740, the process 700 identifies the user that has requested the information, if any user identification is available to the system. At the block 750, the process 700 determines whether additional information is available to the user identified in the block 740. For example, in the block 750, the process 700 may determine that additional information is available to the user because the user is a tenant of the property being accessed. In the block 760, the process 700 retrieves the additional information that is available to the user. In the block 770, the process 700 displays the information. In one embodiment, the process 700 displays the information by transmitted the information to a web browser, such that the web browser displays the information on the user's client computer. At the block 780, the user performs further actions, including, for example, modifying any data, in the block 790, if the user has permission to modify the data. As indicated by the flowchart, the process 700 continues to retrieve and display additional information in response to the user's interaction with the system.

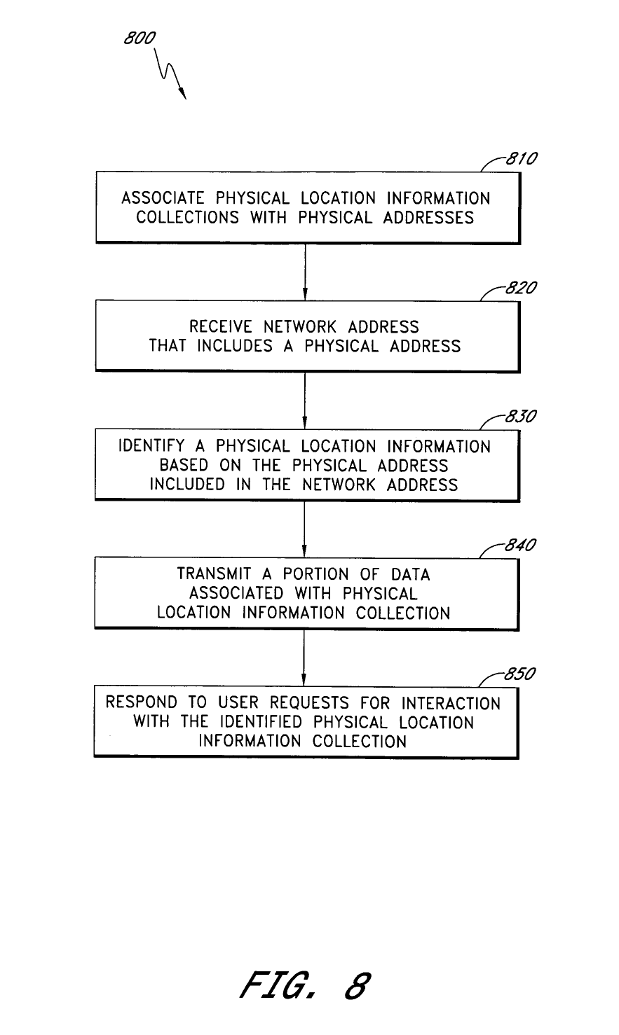

FIG. 8 is a flowchart that illustrates another process for retrieving information about a physical location as performed by an embodiment of the system. The process 800 begins in a block 810 by associating physical location information collections with physical addresses. In one embodiment, each physical location information collection includes information about a physical location, and the collection is identified by a physical address of the physical location. In a block 820, the process 800 receives a network address that includes a physical address. In one embodiment, the network address includes a physical address as part of a domain name of a URL. In another embodiment the network address includes a physical address as part of a path of a URL. A skilled artisan will appreciate, in light of this disclosure, that the physical address can be includes as any part of any other type of network address, so long as the network addressing scheme allows the inclusion of the symbols necessary to represent the physical address.

In a block 830, the process 800 identifies a physical location information collection based on the physical address included in the network address. In a block 840, the process 800 transmits a portion of data associated with the identified physical location information collection to a user. In an optional block 850, the process 800 responds to user requests for interaction with the identified physical location information collection. In one embodiment, responding to such user requests includes allowing users that are members of a community associated with the physical location to have rights to access additional information about the physical location. For example, in one embodiment, users that are tenants of the physical location are allowed to post bulletins in a portion of the collection maintained for the physical location.

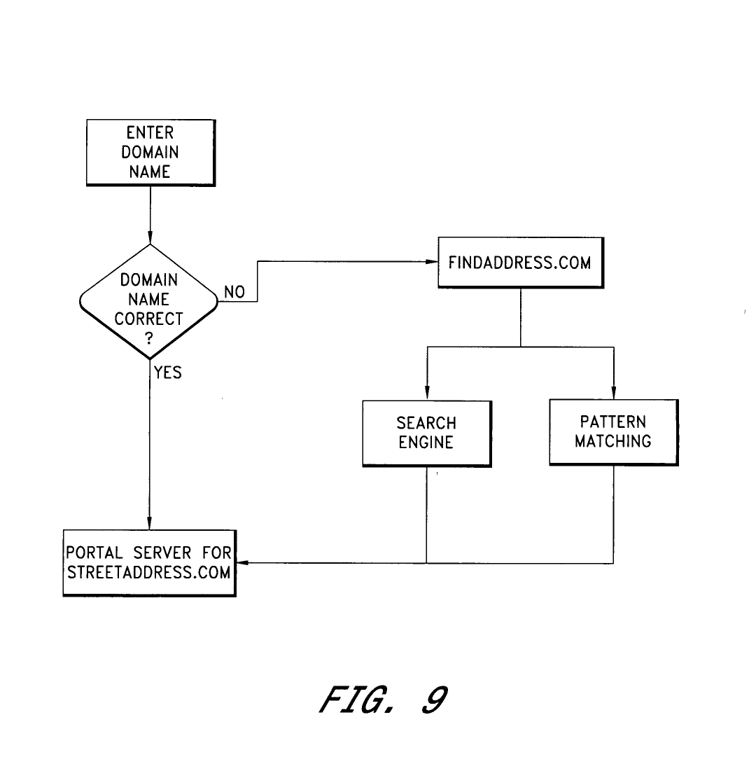

FIG. 9 is a process flow diagram of a domain name resolution process in accordance with an exemplary embodiment of the system. In the process a user enters into a browser, a physical location's name in the form of a street address domain name. If the user knows the naming convention and correctly enters the domain name, the domain name is resolved to an address on the network where the portal server may be accessed. If the domain name is not valid, the user accesses a website to find the proper domain name. The website employs a combination of pattern matching and/or Internet searching to determine a domain name from information supplied by the user. For example, if the user is entering “123MAINST.COM”, pattern matching techniques may be used to determine that the user wants “123MAINSTREET.COM”. As another example, a user may enter “The Gamble House” and search techniques may determine that the address of the Gamble house is “200MAINSTREET.COM”. In this way, a user may use an informal name in order to obtain information about a physical location.

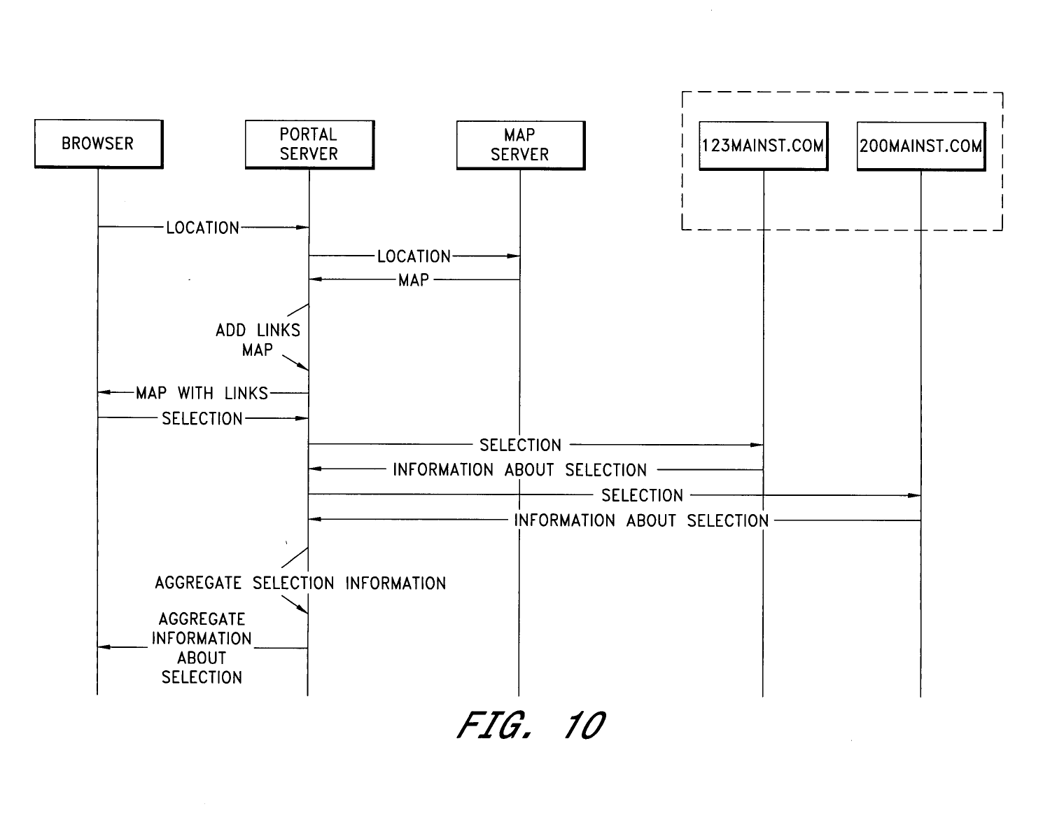

FIG. 10 is a sequence diagram of a map generation process in accordance with an exemplary embodiment of the system. A user uses a browser to access a portal server via a communications network as previously described. The browser transmits a physical location to the portal server. In response, the portal server transmits the physical location to a map server. The map server uses the location information to generate a map in the form of an electronic document such as an HTML page that is transmitted to the portal server. The portal server receives the map. The portal server adds links to physical locations surrounding the location supplied by the user. The map with the inserted links is then transmitted to the browser for display to the user. The user makes a selection from the map and the selection is transmitted back to the portal server. The portal server then uses the selection to generate a database query that is used to query the physical location database. As the physical location database includes information from a plurality of physical locations supplied by, but not limited to, tenants, virtual tenants, visitors and information networks at those physical locations, the information is aggregated before it is presented to the user. For example, if a visitor wants to know if a particular service provider provides satisfactory service, the visitor benefits from a variety of opinions from a plurality of tenants from different physical locations in the neighborhood.

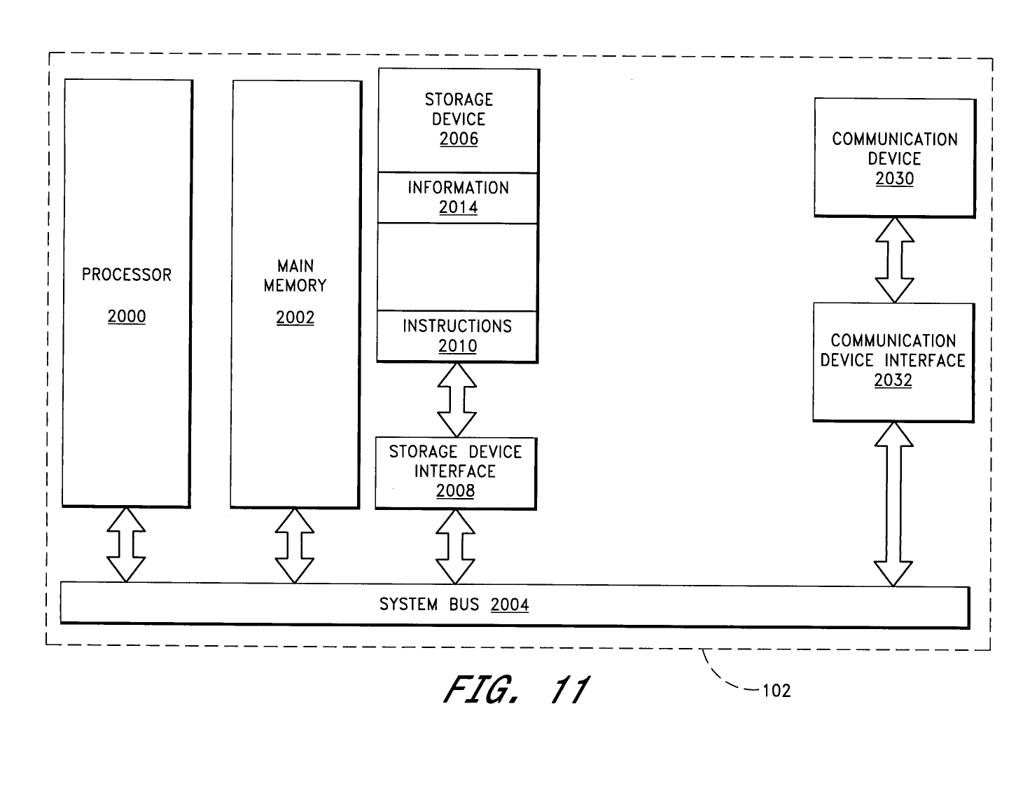

FIG. 11 is an architecture diagram for a host suitable for hosting a portal in accordance with an exemplary embodiment of the system. A portal host 102 includes a processor 2000 coupled to a main memory 2002 via a system bus 2004. The processor is further coupled to a storage device interface 2008 via the system bus. The storage device interface is used by the processor to retrieve programming instructions 2010 stored in a storage device 2006. The processor retrieves the programming instructions and stores them in memory for execution in order to implement the features of a portal server and website generator as described above.

The storage device further includes storage locations for geographically linked information 2014 for each of the physical locations served by the portal server.

The processor is further coupled to a communication device interface 2032 via the system bus. The processor uses the communication device interface to control a communication device 2020 coupled to a communications network (not shown). The processor may then transmit and receive communications, such as presentation scripts and presentation assets, to and from a multi-media presentation server via the communications network.

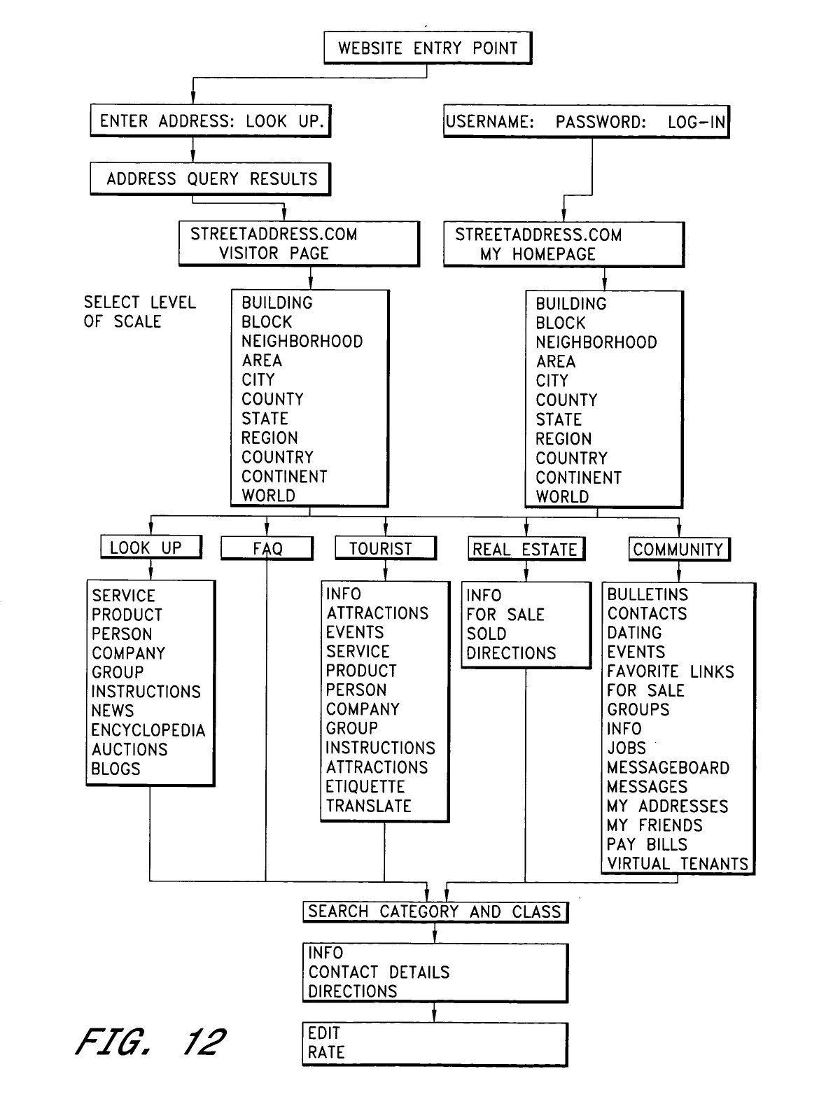

FIG. 12 is a sequence diagram of a text-based generation process in accordance with an exemplary embodiment of the system. A user uses a browser to access a portal server via a communications network of the system. A user uses a browser or portable communications device to access a portal server via a communications network as previously described. The browser or device transmits a physical location to the portal server. In response, the portal server transmits the physical location to a map server. The map server uses the location information to generate a map and then convert the map into a varying level of scales, including building, block, neighborhood, area, city, county, state/province, region, country, continent, world, that is transmitted to the portal server. The list is then transmitted to the browser or screen for display to the user.

The user makes a selection from the geographic scale levels as previously described and the selection is transmitted back to the portal server. The portal then uses the selection to generate a database query that is used to query the physical location database. As the physical location database includes information from a plurality of physical locations supplied by tenants and visitors at those physical locations, the information is aggregated before it is presented to the user at the scale of the user's selection. For example, if a visitor wants to know if a particular service provider provides satisfactory service, the visitor benefits from a variety of opinions from a plurality of tenants or visitors from different physical locations in the geographic scale size. If a tenant wants to know the best restaurant in an entire city, the tenant navigates to the “city” scale level, and the portal server aggregates the results from all the physical restaurant addresses which fall within the scale level.

In one embodiment, the system described herein allows a user to navigate among physical locations using a pictorial representation of a local area. For example, referring to FIG. 2, the system can generate a pictorial map, as shown in FIG. 2, of several local physical locations. In this embodiment, such a map is used as a navigation tool to access information collected by the system. In the map, a user may select individual buildings in order to access information about the physical location. For example, a user may select a service provider, such as a dry cleaner, to find out how residents of the neighborhood rate the dry cleaner's services. By enlarging the area displayed within the map, information about entire neighborhoods, cities, and regions may be navigated.

Having described one exemplary computer and software architecture of the system and method described herein, some applications of the system are now described. [0106] The system helps maximize the efficiency with which people search for goods, services, locations, people, communities, businesses, groups, events, instructions, news, blogs, directions, auctions, attractions and other localized information; and interface with the local community, including but not limited to friends, dating and social networks, associations, virtual tenants, events, jobs, bill paying services, and links. The website for building addresses can be accessed by a mobile or stationary computing device, such as cell phones, car navigational systems, personal computers, personal digital assistants (“PDAs”), etc.

For example, any GPS-based system device could access the database to find any recommended information, including but not limited to local merchants, restaurants, real estate information, tourist landmarks and best local parking locations. The system could be accessed by, but not limited to, clicking on a linked building displayed on any GPS-based system device; or by entering an exact street address or any version thereof.

Thus, in accordance with the embodiments described herein, the system is able to provide dynamic, location-sensitive, rated information automatically and perform other useful tasks by correlating a vehicle or portable device to data stored in a remote database to identify geographically pertinent information and by transmitting the geographically pertinent information to the vehicle, mobile device or stationary user.

The system can provide restaurants, stores or businesses with the capabilities of delivery or pick-up to be interconnected by way of specific address allowing for personalized on-time orders of exact specifications. This provides the capacity for immediate acknowledgement and approval and disapproval of order or request.

In one embodiment, each individual property's unique homepage has information about the actual real property, and shared dynamic information (with other properties in the network) specific to the neighborhood.

The information collected on the website may include links and reviews, and represents a continuing dynamic collaborative effort between users, who are able to individually contribute data to the present information on each homepage.

The system increases in information complexity through the network effects of people (specifically by people defined in “The Tipping Point” by Malcolm Gladwell as “Mavens”) adding data continually over time to create an ever-increasing collation of up-to-date, locally based community and building information. Each individual property's website may be regulated by an individual volunteer or volunteers known as a building “Concierge” who validates new data from regular user submissions on an individual or regional level. This content may include, but not limited to, the best places to park, local directions, local streets to avoid at certain times of the day, a local history, where to park on certain days to avoid street cleaning, preferred local vendors, HOA notices and newsletters, new rules and regulations on a building and neighborhood level, planned community developments, services needed, restaurant and service reviews, job opportunities, tourist attractions and information, events, links, safety precautions, helpful information, reviews on services (such as window cleaning) and referrals by the service sector, etc.

The property URL is also linked to other properties in its neighborhood, and shares real-time data, including reviews of local vendors, which is inputted by users and edited by a volunteer network of other pre-approved community users. New information is asked for approval by residents of the building; emailed to assignee for immediate verification and/or validation; or by votes from users. The method and system described herein allow the building community and members in the neighborhood to continuously interact and facilitate transactions by efficiently exchanging accurate and standardized rated information through links. The system provides an opportunity for increased, and individually controlled, interaction amongst community members.

Navigation of the system can be aided by splitting the globe into geographic areas, as before mentioned, based on a hierarchical scale such as neighborhood, block, city, state, country. By centralizing and standardizing the information, it is made much more user friendly and much more valuable and can reduce search time for local services, information and reviews.

The website in the system can operate as dynamically created templates with inviting themes to make it a comfortable and welcoming place in which to invite users to explore and contribute data. The website templates can project a consistent look and feel across every building address homepage.

Physical buildings and other structures can have signage or other notices, e.g., such as www.anyaddress.com, indicating secure computers with access to the building information within the confines of the lobby/entry is available, or the building has subscribed to the information network system described herein. Optionally, a secure computer can be provided in a lobby or common areas of a building for residents and/or visitors to access the data, e.g., while waiting for taxis or traversing through the common area to check messages, to verify community events, etc. There can also be private access for home owner associations/owners via username and password entries in the personalized log-in area.

Since real estate is one primary target for advertisers, the URLs could be leased to a real estate company and in turn sub-leased to multiple realtors from varying real estate companies. Realtors can be on the websites of particular pieces of property. This in and of itself can become a “billboard” for leasing by real estate companies, and can help facilitate the search of commercial and residential real estate databases. The building address is the primary focus from which all advertising stems. This in turn provides a method and format that facilitates real estate transactions by way of an easily navigable naming convention, providing a consistent familiar branding for real estate brokers, buyers and sellers. As part of the system, commercial brokers can control the distribution of information when selling a building. e.g., through a password-organized building section. If desired, enlisted brokers register additional URLs at no cost. The system can also be similarly used by developers or any other service providers. The system allows sellers and their brokers to advertise a building or units for sale within a given building to a broad audience, but in a controlled specific manner.

Said property information is obtained from the database and includes at least a market status on the item of property. The method and system provides a way for the business and residential communities to identify properties and market to potential buyers and tenants. For buyers of real estate, the method and system described herein can be a repository of the latest comparable sales information for the building and other local buildings. Realtors can be on the website of particular pieces of property which help facilitate the search of commercial and residential real estate databases.

Similarly, the system can be used for obtaining current dynamic statistical information for any variety of services, including but not limited to, real estate, market research companies, investment companies, marketers, and businesses for the area of interest.

For owners of real estate, the method and system can help facilitate the sale, resale, rent or lease of the real estate, provide information, goods and services to that specific physical and surrounding neighborhood, and functions for the community's users, including renters, buyers, sellers, brokers, developers, members of the local community, salespeople, tourists, vendors and special interest groups.

As with realtors, other advertisers can gain a strong Internet presence for each dedicated address, ultimately an “exclusive” on that individual building, thereby allowing them to become/focus their advertising dollars by being in front of each of the residences via the building websites. These advertisers can, for example, be local businesses who really can offer specialized value to those associated with the building and do so cost effectively. This space can be offered as a limited resource to the highest bidder, renegotiated after a negotiated period of time.

Some of the types of content for the individual websites can include the following: history of building; directory of virtual and real physical tenants; live webcam of building exterior; Links; top recommendations; most popular requested services by residents such as taxis; bulletins, photo galleries, etc. The information provided to the user would include: links to real estate brokers who advertise; weather, local time and data; relevance for local markets; bill paying services; chat rooms; localized chat rooms; ride-sharing coordination; discussion forums; finding, walking and exercise buddies; personals; lost and found; services needed; classifieds; and aggregated information from the Internet, such as news, blogs, etc.

Globally, all information centers, such as libraries and public transportation centers including every city of every country, are linked by their physical street address to the information network system. Similarly airports are linked via their airport terminal addresses. For example, Los Angeles International Airport (LAX), located at 1 World Way, Los Angeles, Calif., United States of America, becomes accessed from 1WORLDWAY.COM. The airport not only remains a hub of physical transportation but becomes a virtual travel hub for information between other cities and locations.

On the specific building address website there can be a building section used specifically for residents. Physical tenants can be provided with a log-in account and a homepage customizable with favorite links; local contact information; bill paying services; building-only messageboards and bulletins, etc., and given authorization to approve unverified local information. All pertinent resident-only building-based information, including emergency telephone numbers, local utility companies and respective contact information, building approved trades and related links.

The method and system described herein provides the possibility of having “virtual tenants”. “Space” at the building's URL can be leased in the form of an email address or server space on the URL, allocated for a pre-determined period of time to the highest bidder. For example, the selling and leasing of email addresses at a given virtual street address (sports enthusiasts getting emails at their favorite arena, such as Yankee Stadium, users selecting their favorite monument as their email address) is possible. The leasing of virtual suites for each URL allows users to have a prestigious address for personal or business virtual use because addresses have emotional and psychological branding attachment. This can also create a sub-virtual community, e.g., all the sports enthusiasts that have a Yankee Stadium address, i.e., yankeebrian@1EAST61STSTREET.COM, combine to create a completely new community paradigm, or rather a community within a community. By becoming a virtual tenant of the Yankee Stadium, the lessee of the virtual address is allowed to create their own unique homepage once the address and suite number (or in this case, “seat number”) are entered, and is automatically connected to every other virtual tenant of that specific address through their community contacts section on their virtual tenant log-in page, strengthening the social network effects of this system.

As referenced before, email addresses and virtual real estate on the site can be sold based on a leased on a bid-based system of supply and demand. This applies to landmark buildings or structures, museums, churches, or any other in-demand physical address on the network. Email addresses can also be leased to vendors and service providers as advertising who wish to advertise their services to the building's physical occupants.

The information network created by the system and method described herein provides an interactive marketplace that enables residents, brokers, advertisers to reach a larger more organized network of increased distribution by interlinked website network creating high visibility and cost effective marketing.

Tourists are also specifically catered to within the information network. A tourist visiting any location in the world, can input their current physical address into the system, and immediately connect to rated and up-to-date localized information and services. This includes but is not limited to, tourist information, local attractions, events, services, products, people, companies, groups, instructions, etiquette and language translation into the local language based from their primary physical home address. By doing so, the tourist is now an active part of what was traditionally a foreign environment.

In an era where society and the Internet have always been separated and disconnected, the method and system described herein provides a dynamically ranked information network allowing people within their respective physical building street address (business or home) to participate in their community and collaborate with their global neighbors from a local level. The system and method described herein provides a new paradigm into how we relate to information, location, and society, and provides an advantageous bridge between virtual and physical reality.

Several preferred embodiments of the system and method have been described by way of illustration. However, the invention is not limited solely to the preferred embodiments described herein. Instead, the preferred embodiments are intended as illustrations of various principles regarding the invention. A skilled artisan will appreciate, in light of the various principles taught by this disclosure, how to implement not only the embodiments described herein but also variations of those embodiments that do not depart from the invention. In particular, a skilled artisan will appreciate that many of the features of certain preferred embodiments are optional and need not be present in every embodiment. In accordance with the foregoing, the claims alone, and not the preferred embodiments of this disclosure, define and limit the invention.

1. A system for storing and retrieving information comprising:
a first collection of electronic information pertaining to physical locations, each physical location being identified by a physical address stored in at least one data field;
a second collection of electronic information having information related to at least one of the physical locations within the first collection of electronic information;
a third collection of electronic information pertaining to users of the system;
and
a host server interconnected by a computer network to the first collection of electronic information, the second collection of electronic information, and the third collection of electronic information, and configured to receive a network address that has, within the network address, at least one physical address associated with at least one of the physical locations, to identify, based on the physical address, at least one of the physical locations, and to display information about the identified physical location.

2. The system of claim 1, wherein the physical address comprises at least one of a street address, a postal address, and a multi-dimensional coordinate, and wherein the physical address does not consist entirely of a name of a city.

3. The system of claim 1, wherein the network address comprises a plurality of characters and wherein a majority of such characters match a physical address corresponding to a physical location.

4. The system of claim 3, wherein the characters comprise a combination of numbers, characters, letters, and symbols.

5. The system of claim 1, wherein the physical address comprises at least one Global Positioning System coordinate.

6. The system of claim 1, wherein the second collection of electronic information includes information that indicates a level of relevance of the information to a physical location.

7. The system of claim 1 wherein information associated with a physical location has a range attribute that indicates a level of relevance of the information to other physical locations.

8. The system of claim 1, wherein the physical address comprises a name of a building.

9. The system of claim 8, wherein the name of the building uniquely identifies a physical location.

10. The system of claim 1 wherein the physical address comprises a telephone number.

11. The system of claim 1 wherein the network address is entered by a user using a telephone keypad.

12. The system of claim 1 wherein the information about the identified physical location is displayed using a browser.

13. The system of claim 1, wherein the network address comprises a Uniform Resource Locator.

14. The system of claim 13, wherein the physical address is included within a domain name of a Uniform Resource Locator.

15. The system of claim 14, wherein the physical address is included within a second-level domain portion of a Uniform Resource Locator.

16. The system of claim 13, wherein the physical address is included within two characters from the end of a top-level domain of a Uniform Resource Locator.

17. The system of claim 1 wherein the physical address within the network address has been split into parts.

18. A method of retrieving information related to a physical location comprising:
receiving over a network a user request including a network address that has within the network address at least a portion of a physical address;
extracting the physical address from the network address and identifying, from the physical address, at least one information collection comprising information about a physical location corresponding to the physical address;
aggregating information from the information collection with information related to the physical location stored in at least one other information collection; and
transmitting the information about the physical location and the information related to the physical location to a user.

19. The method of claim 18, wherein the network comprises the Internet.

20. The method of claim 18, wherein the network comprises a network of cellular telephones.

21. The method of claim 18, wherein receiving a user request comprises receiving a user request generated at least in part by a user entering a network address into a browser.

22. The method of claim 18, wherein receiving a user request comprises receiving a user request generated at least in part by a user selecting at least one link on a web page.

23. The method of claim 18, further comprising identifying a user.

24. The method of claim 23 wherein identifying a user comprises a process of self-identification by the user.

25. The method of claim 23, wherein identifying a user comprises identifying a user by the user's physical location at the time that the user invokes the method.

26. The method of claim 18, wherein receiving a user request comprise receiving a user request that is made by the user by speaking at least one sound.

27. The method of claim 18, wherein receiving a user request comprises receiving user input on a device that automatically generates, based on the received user input, the user request, and transmits the request over the network.

28. The method of claim 18, wherein receiving a user request comprises receiving a user request that has been manually generated by the user.

29. The method of claim 18, wherein the network address comprises a Uniform Resource Locator

30. The method of claim 18, wherein the physical address comprises a street address.

31. The method of claim 18, wherein the physical address comprises a string of characters.

32. The method of claim 31, wherein the physical address is at least part of a sub-domain in a Uniform Resource Locator.

33. The method of claim 31, wherein the physical address is at least part of a domain of a Uniform Resource Locator.

34. The method of claim 31, wherein the physical address is the whole of a Uniform Resource Locator.

35. The method of claim 18, wherein the information returned to the user comprises textual information.

36. The method of claim 18, wherein the information returned to the user comprises graphical information.

37. The method of claim 18, wherein the information returned includes at least a portion of data that is not directly related to the physical location.

38. The method of claim 18, wherein the information returned to the user is in a structured data format.

39. The method of claim 38, wherein the format comprises XML.

40. The method of claim 38, wherein the format is user-specified.

41. The method of claim 38, wherein the format comprises a database.

42. The method of claim 18, further comprising displaying the information returned to the user on a computer screen.

43. The method of claim 18, wherein the information is returned to a separate user than the user that made the user request.

44. The method of claim 18, wherein the user comprises an electronic device.

45. The method of claim 18, wherein the user is a person.

46. The method of claim 18, wherein the user comprises a software program.

47. The method of claim 18, wherein the information returned includes advertising.

48. The method of claim 18, wherein the information returned includes real estate listings.

49. The method of claim 18, wherein the information returned includes real estate listings for an area in a defined proximity to the physical location.

50. The method of claim 18, wherein the information returned includes traffic information to or from the physical location.

51. The method of claim 18, wherein the content and quantity of information returned to the user is dependent on attributes of the user stored in an information collection.

52. The method of claim 18, wherein the user can alter the content of information returned on current or subsequent accesses of the system.

53. The method of claim 18, wherein the physical address comprises a telephone number.

54. The method of claim 18, wherein the physical address comprises a multi-dimensional coordinate.

55. A geographical information system comprising:
a collection of information relevant to a geographical location, the collection being connected to a network;
an interface to the collection configured to provide user access to the collection over the network, such access being provided, at least in part, by receiving, over the network, a network address that identifies the collection, the network address comprising, as a host name of the network address, at least a portion of a physical street address; and
an output module configured to retrieve information from the information collection and transmit the information to a user;
wherein the system provides a variable level of access for users wherein a user is allowed to alter varying quantities of content in the information collection based on user attributes stored in the information collection.

56. The system of claim 55, wherein the network comprises the Internet.

57. The system of claim 55, further comprising a transaction module configured to manage transactions between users related to physical locations stored in the information collection.

58. The system of claim 57, wherein at least one of the transactions managed by the transaction module involves an exchange of money or advertising.

59. The system of claim 57, wherein at least one of the transaction specifies a time span for the transaction to take effect.

60. The system of claim 57, wherein, with regard to at least one of the transactions, at least one of the parties to the transaction have the last right of refusal over other parties interested in the transaction.

61. The system of claim 57, wherein, with regard to at least one of the transactions, an auction is held to determine a party that is allowed to participate in the transaction.

62. A method of virtualizing physical locations comprising:
associating a plurality of physical location information collections with physical addresses such that each collection comprises data related to a physical location identified by at least one physical address;
receiving a network address that includes a physical address;
identifying at least one of the collections based on the physical address included in the network address; and
transmitting a portion of the data related to a physical location from the identified collection.

63. The method of claim 62, wherein the physical address included in the network address comprises at least a portion of at least one of a street address, a postal address, a building name, a spatial coordinate, and a global positioning system coordinate.

64. The method of claim 62, wherein the portion of the data related to a physical location that is transmitted comprises information about at least one of people, restaurants, services, entertainment, and news associated with the physical location.

65. The method of claim 62, wherein the network address received comprises a Uniform Resource Locator.

66. The method of claim 65, wherein the Uniform Resource Locator includes the physical address within a host name of the Uniform Resource Locator.

67. The method of claim 65, wherein the Uniform Resource Locator includes the physical address within a path of the Uniform Resource Locator.

68. The method of claim 62, further comprising responding to user requests for interaction with the identified electronic collection of geographical information.

69. The method of claim 68, wherein responding to user requests for interaction comprises identifying users that are members of a community associated with the physical location and granting to such community members a higher level of access to the data related to the physical location than is granted to users that are not community members.

70. The method of claim 69, wherein users that live within the physical location are identified as members of the community.

71. The method of claim 69, wherein the higher level of access granted to community members includes being able to modify at least a portion of the data related to the physical location.

72. A geographical information system comprising a plurality of physical location information collections connected to a computer network, each collection comprising data related to a physical location identified by at least one physical address, the geographical information system configured to receive a user request comprising a network address that includes a physical address, to identify, based on the physical address included in the network address, one of the collections, and to transmit to the user at least a portion of the data related to the physical location identified by the physical address.

73. The geographical information system of claim 72, further comprising at least one physical location information collection server, wherein at least two of the collections are stored on the at least one electronic information collection server.

74. The geographical information system of claim 72, further comprising an address resolution module configured to receive, as part of a network address, at least a portion of a physical address, to match the portion of a physical address with one of the physical addresses that identifies a physical location for which data is stored in one of the collections, and to cause the geographical information system to transmit to the user at least a portion of the data related to the physical location identified by the matched physical address.

75. The geographical information system of claim 72, further comprising a global positioning system coordinate module configured to receive, as part of a network address, at least one global positioning system coordinate, to match the global positioning system coordinate with a physical address by determining which physical address corresponds to a physical location located at the global positioning system coordinate, and to cause the geographical information system to transmit to the user at least a portion of the data related to the physical location identified by the matched physical address.

76. A program storage device storing instructions that when executed perform the process comprising:
associating a plurality of physical location information collections with physical addresses such that each collection comprises data related to a physical location identified by at least one physical address;
receiving a network address that includes a physical address;
identifying at least one of the collections based on the physical address included in the network address; and
transmitting a portion of the data related to a physical location from the identified collection.

77. The program storage device of claim 76, wherein the process performed by the instructions when executed further comprises responding to user requests for interaction with the identified collection.

78. The method of claim 77, wherein responding to user requests for interaction comprises identifying users that are members of a community associated with the physical location and granting to such community members a higher level of access to the data related to the physical location than is granted to users that are not community members.

79. A system for virtualizing physical locations comprising:
means for associating a plurality of physical location information collections with physical addresses such that each collections comprises data related to a physical location identified by at least one physical address;
means for receiving a network address that includes a physical address;
means for identifying at least one of the collections based on the physical address included in the network address; and
means for transmitting a portion of the data related to a physical location from the identified collection.

80. The system of claim 79, further comprising means for responding to user requests for interaction with the identified electronic collection of geographical information.

81. The system of claim 80, wherein responding to user requests for interaction comprises identifying users that are members of a community associated with the physical location and granting to such community members a higher level of access to the data related to the physical location than is granted to users that are not community members.
